(19) United States
(12) Patent Application Publication
(10) Pub. No.: US 2010/0072891 A1
(43) Pub. Date: Mar. 25, 2010

(54) LIGHT EMITTING DIODE ILLUMINATION ASSEMBLY

(75) Inventors: HUNG-TA LIAO, Taipei County (TW); HONG-SYUN CHOU, Taipei County (TW)

Correspondence Address: ROSENBERG, KLEIN & LEE, 3458 ELLICOTT CENTER DRIVE-SUITE 101, ELLICOTT CITY, MD, 21043, US

(73) Assignee: EDISON OPTO CORPORATION, TAIPEI HSIEN (TW)

(21) Appl. No.: 12/235,841

(22) Filed: Sep. 23, 2008

(51) Int. Cl. H01J 1/62

(52) U.S. Cl. 313/512; 313/498

(57) ABSTRACT

A light emitting diode (LED) illumination assembly comprises a base, at least one first LED chip and at least one light modulation subassembly. The base is formed with a receiving groove, in which at least one first arrangement region and at least one second arrangement region recessed from the first arrangement region are located. The first LED chip is mounted on the first arrangement region for projecting at least one first light beam. The light modulation subassembly comprises a second LED chip and a light-transmissible layer. The second LED chip is mounted on the second arrangement region for projecting a second light beam. The light-transmissible layer contains phosphor powder, and covers the second LED chip. The second light beam is stimulated after transmitting through the light-transmissible layer, and mixes with the first light beam after being stimulated, so as to generate an illumination light beam.

### FIELD OF THE INVENTION

The present invention relates to a light emitting diode (LED) illumination assembly, and more particularly to an LED illumination assembly with LED chips mounted in different heights.

### BACKGROUND OF THE INVENTION

In the daily life, the light emitting diode (LED) chips are usually mounted on some bases to manufacture many types of illumination assemblies due to that the LED chips can project light beams. In the prior arts, more preferably, each one of the illumination assemblies comprises three LED chips respectively projecting light beams with different colors, such as red, green and blue colors. Generally speaking, the three LED chips are usually electrically connected to three (branch) independent circuits, and the intensities of the light beams projected from the three LED chips can be controlled by controlling the driving current passing through the (branch) independent circuits.

For further presenting the prior arts as mentioned above, following up, more detailed description and figures would be provided to illustrate the most representative LED illumination assembly in accordance with the prior arts. Please refer to FIG. 1 and FIG. 2, wherein FIG. 1 is a partially exploded view illustrating the main components of a conventional LED illumination assembly; and FIG. 2 illustrates that three LED chips are respectively mounted on three arrangement regions in the conventional LED illumination assembly. As shown in the figures, an LED illumination assembly 100 comprises a base 1, an LED chip group 2 and a light-transmissible packaging cover 3.

The base 1 comprises a base body 11. A receiving groove 12 is recessed from the base body 11, and comprises a groove bottom 121 and a groove opening 122. Six (three pairs of) electrode contacts 121a, 121b, 121c, 121d, 121e and 121f are located on the groove bottom 121. Moreover, the base 1 further comprises six (three pairs of) electrically conductive pins 13a, 13b, 13c, 13d, 13e, 13f, and three arrangement regions 14a, 14b and 14c substantially located in the same horizontal level within the receiving groove 12. The electrically conductive pins 13a, 13b, 13c, 13d, 13e and 13f are electrically connected with the electrode contacts 121a, 121b, 121c, 121d, 121e and 121f respectively, and extended out of the receiving groove 12. Preferably, the electrically conductive pins 13a, 13b, 13c, 13d, 13e and 13f are extended out of the base body 11. The LED chip group 2 includes three LED chips 21, 22 and 23.

When assembling the LED illumination assembly 100, it is necessary to respectively mount the LED chips 21, 22 and 23 on the arrangement regions 14a, 14b and 14c. Then, it is necessary to electrically connect the LED chip 21 to the electrode contacts 121a and 121d, electrically connect the LED chip 22 to the electrode contacts 121b and 121e, and electrically connect the LED chip 23 to the electrode contacts 121c and 12 1f respectively. Finally, it is necessary to assemble the light-transmissible packaging cover 3 to the groove opening 122, so as to cover the receiving groove 12 and package the LED chip group 2 therein.

After completing above electrical connections, it is obvious that the electrically conductive pin 13a, the electrode contact 121a, the LED chip 21, the electrode contact 121d and the electrically conductive pin 13d are electrically connected with each other to form a first (branch) circuit; the electrically conductive pin 13b, the electrode contact 121b, the LED chip 22, the electrode contact 121e and the electrically conductive pin 13e are electrically connected with each other to form a second (branch) circuit; and the electrically conductive pin 13c, the electrode contact 121c, the LED chip 23, the electrode contact 121f and the electrically conductive pin 13f are electrically connected with each other to form a third (branch) circuit.

Please refer to FIG. 3, which illustrates that in the prior arts, three light beams projected from the three LED chips are mixed to generate an illumination light beam. As shown in FIG. 3, after supplying the driving currents to the first (branch) circuit, the second (branch) circuit and the third (branch) circuit, the LED chips 21, 22 and 23 respectively project three light beams LB1, LB2 and LB3. The light beams LB1, LB2 and LB3 are mixed to generate an illumination light beam ILB0, which is applied to provide illumination to external environment.

After reading above description, it is believable that any person skilled in ordinary art can easily realize the facts as follows.
Firstly, generally speaking, the light beams LB1, LB2 and LB3 can be red, green and blue light beams respectively.
Secondly, the intensities of the light beams LB1, LB2 and LB3 can be controlled by controlling the driving currents passing through to the first (branch) circuit, the second (branch) circuit and the third (branch) circuit.
Thirdly, from the experiment results, when the LED chips 21, 22 and 23 are red-light, green-light and blue-light LED chips respectively, the light beams LB1, LB2 and LB3 can be mixed to generate a white light beam with a luminous efficacy approximate to 30-50 lumens per watt. Additionally, the maximum spatial deviation of color temperature for the white light beam is greater than 3000 K. Obviously, the luminous efficacy and the homogeneousness of color temperature distribution need to be further improved.

### SUMMARY OF THE INVENTION

Due to that the LED illumination assembly of prior art exists the problems of that the luminous efficacy and the homogeneousness of color temperature distribution need to be further improved, the primary objective of the present invention provides at least one first LED chip and at least one second LED chip, and the second LED is covered with a light-transmissible layer containing phosphor powder. More importantly, the first LED chip and the second LED chip are mounted on the arrangement regions in different heights.

Means of the present invention for solving the problems as mentioned above provides a light emitting diode (LED) illumination assembly, which comprises a base, at least one first LED chip and at least one light modulation subassembly. The base is formed with a receiving groove, in which at least one first arrangement region and at least one second arrangement region recessed from the first arrangement region are located. The first LED chip is mounted on the first arrangement region for projecting at least one first light beam. The light modulation subassembly comprises a second LED chip and a light-transmissible layer. The second LED chip is mounted on the second arrangement region for projecting a second light beam. The light-transmissible layer contains phosphor powder, and covers the second LED chip. The second light beam is stimulated after transmitting through the light-transmissible layer, and mixes with the first light beam after being stimulated, so as to generate an illumination light beam.

Comparing with the conventional LED illumination assembly as disclosed in prior arts, in the present invention, the recessed depth provides a height deviation; therefore, it is able to mount the first LED chip and the second LED chip in different heights, so as to make the illumination light beam have better homogeneousness of color temperature distribution. Nevertheless, in the present invention, the first light beam is further mixed with the second light beam after the second light beam is stimulated by the light-transmissible layer, so that it is able to raise the luminous efficacy of the illumination light beam.

The devices, characteristics, and the preferred embodiment of this invention are described with relative figures as follows.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG.1 is a partially exploded view illustrating the main components of a conventional LED illumination assembly;

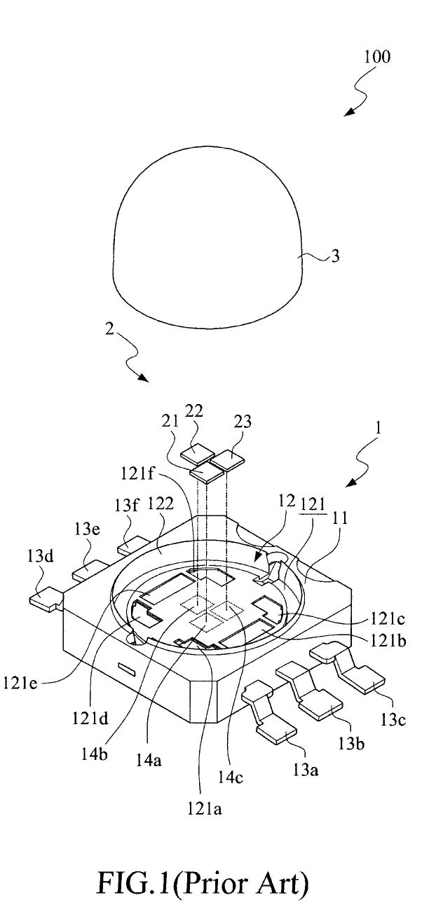

FIG. 2 illustrates that three LED chips are respectively mounted on three arrangement regions in the conventional LED illumination assembly;

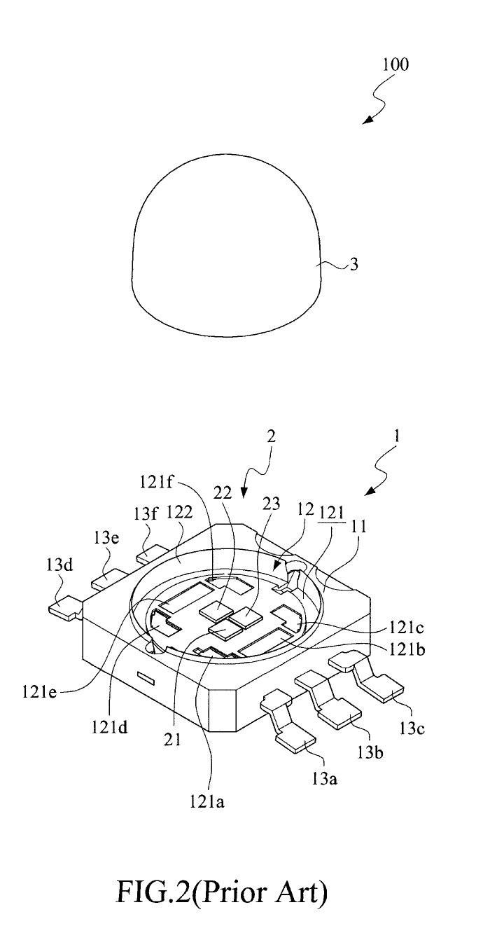

FIG. 3 illustrates that in the prior arts, three light beam projected from the three LED chips are mixed to generate an illumination light beam;

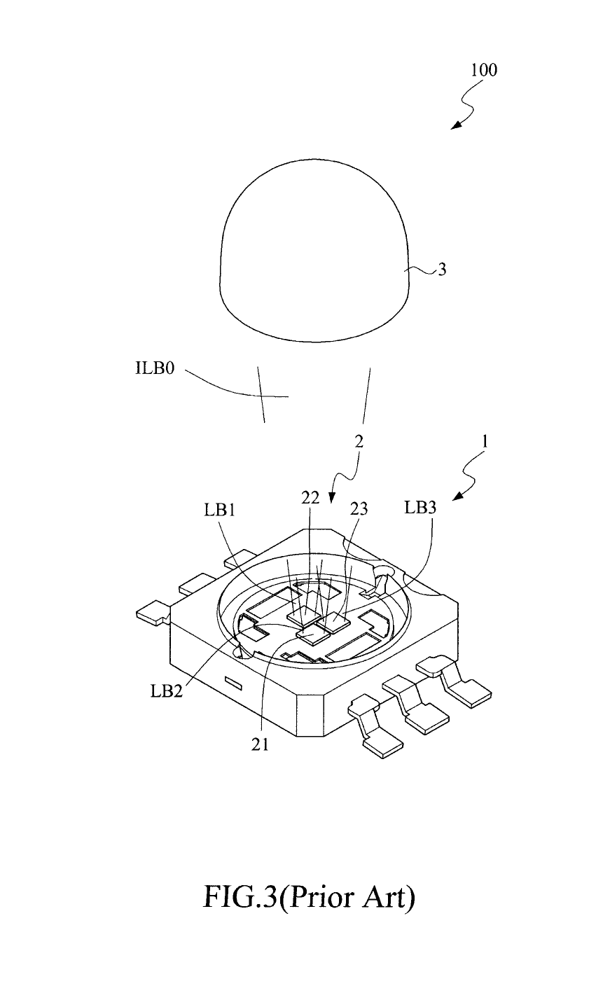

FIG. 4 is a partially exploded view illustrating the main components of an LED illumination assembly in accordance with a preferred embodiment of the present invention;

FIG. 5 illustrates that three first LED chips and a second LED chip are respectively mounted on three first arrangement regions and a second arrangement region of an arrangement platform in accordance with the preferred embodiment of the present invention; and

FIG. 6 illustrates that in the preferred embodiment of the present invention, a second light beam projected from the second LED chip is stimulated after transmitting through the light-transmissible layer, and mixed with three first light beams projected from the three first LED chips to generate an illumination light beam.

### DETAILED DESCRIPTION OF THE PREFERRED EMBODIMENTS

The LED illumination assembly as provided in accordance with the present invention can effectively generate the illumination light beam with better homogeneousness of color temperature distribution through the existence of the height deviation, and further raise the luminous efficacy via mixing the first light beam and the second light beam after the second light beam is stimulated by the light-transmissible layer. Therefore, the present invention can be widely applied to many kinds of illumination. Obviously, the combined applications of the present invention are too numerous to be enumerated and described, so that only one preferred embodiment is disclosed as follows for representation.

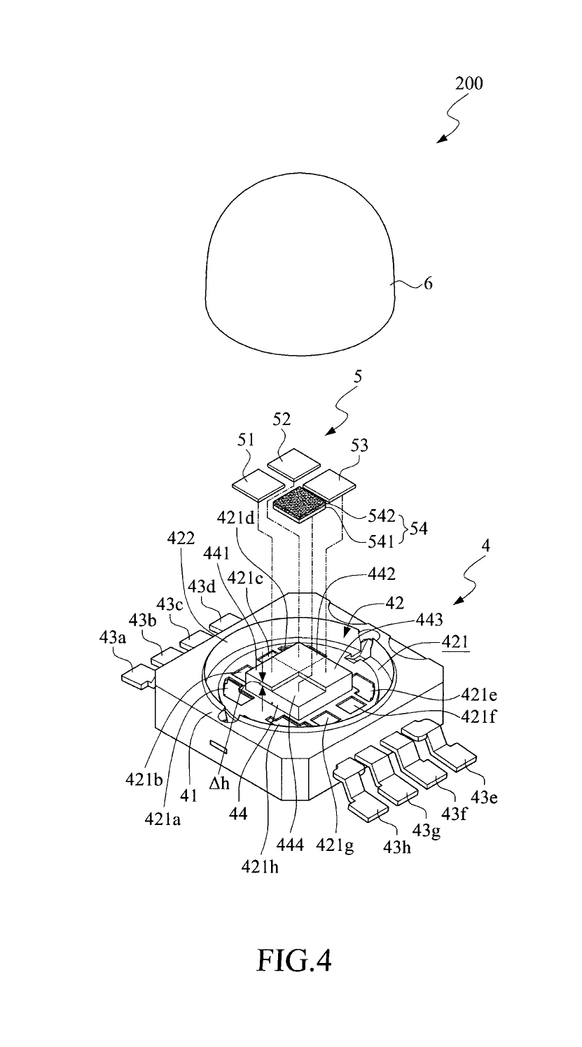

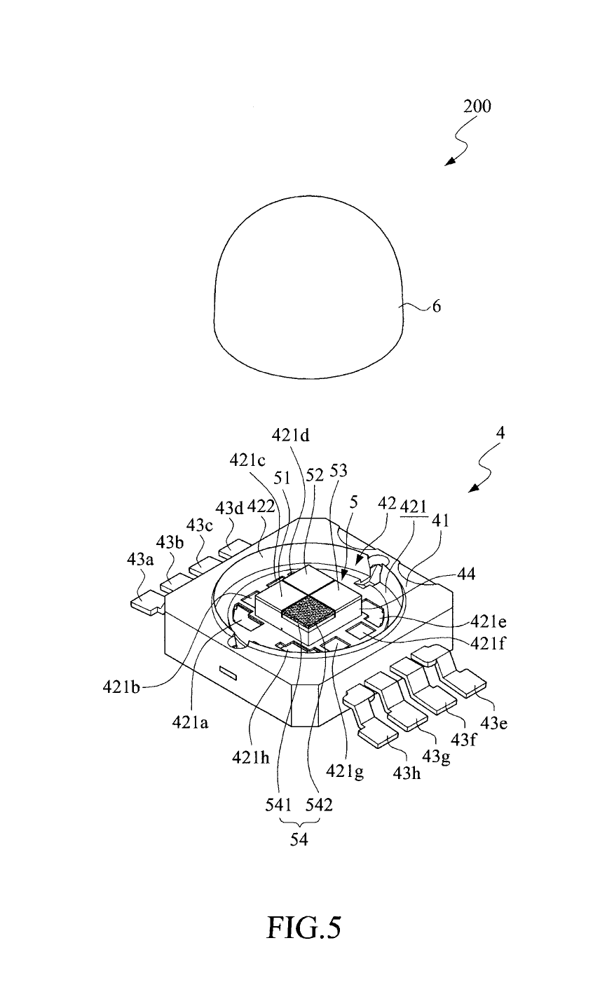

Please refer to FIG. 4 and FIG. 5, wherein FIG. 4 is a partially exploded view illustrating the main components of an LED illumination assembly in accordance with a preferred embodiment of the present invention; and FIG. 5 illustrates that three first LED chips and a second LED chip are respectively mounted on three first arrangement regions and a second arrangement region of an arrangement platform in accordance with the preferred embodiment of the present invention. As shown in the figures, an LED illumination assembly 200 comprises a base 4, an LED chip group 5 and a light-transmissible packaging cover 6.

The base 4 comprises a base body 41. A receiving groove 42 is formed on the base body 41, and comprises a groove bottom 421 and a groove opening 422. Eight (four pairs of) electrode contacts 421a, 421b, 421c, 421d, 421e, 421f, 421g and 421h are located on the groove bottom 421. Moreover, the base 4 further comprises eight (four pairs of) electrically conductive pins 43a, 43b, 43c, 43d, 43e, 43f, 43g, 43h and an arrangement platform 44. The electrically conductive pins 43a, 43b, 43c, 43d, 43e, 43f, 43g and 43h are electrically connected with the electrode contacts 421a, 421b, 421c, 421d, 421e, 421f, 421g and 421h respectively, and extended out of the receiving groove 42. Preferably, the electrically conductive pins 43a, 43b, 43c, 43d, 43e, 43f, 43g and 43h are extended out of the base body 41. The arrangement platform 44 includes three first arrangement regions 441, 442 and 443 and a second arrangement region 444. The first arrangement regions 441, 442 and 443 are substantially located in the same horizontal level, and the second arrangement region 444 is neighboring to the first arrangement regions 441 and 443, and recessed from the first arrangement regions 441 and 443 in a recessed depth to provide a height deviation Δ h.

The LED chip group 5 includes three first LED chips 51, 52, 53 and a light modulation subassembly 54. The light modulation subassembly 54 comprises a second LED chip 541 and a light-transmissible layer 542. The light-transmissible layer 542 contains phosphor powder, and can be made by injecting light-transmissible gel.

When assembling the LED illumination assembly 200, it is necessary to respectively mount the first LED chips 51, 52 and 53 on the first arrangement regions 441, 442 and 443 of the arrangement platform 44, and mount the second LED chip 541 on the second arrangement region 444. Then, it is necessary to electrically connect the first LED chip 51 to the electrode contacts 421a and 421b, electrically connect the first LED chip 52 to the electrode contacts 421c and 421d, electrically connect the first LED 53 to the electrode contacts 421e and 421f, and electrically connect the second LED 541 to the electrode contacts 421g and 421h. Finally, it is necessary to assemble the light-transmissible packaging cover 6 to the groove opening 422, so as to cover the receiving groove 42 and package the LED chip group 5 therein.

After completing above electrical connections, it is obvious that the electrically conductive pin 43a, the electrode contact 421a, the first LED chip 51, the electrode contact 421b and the electrically conductive pin 43b are electrically connected with each other to form a first circuit; the electrically conductive pin 43c, the electrode contact 421c, the first LED chip 52, the electrode contact 421d and the electrically conductive pin 43d are electrically connected with each other to form a second circuit; the electrically conductive pin 43e, the electrode contact 421e, the first LED chip 53, the electrode contact 421f and the electrically conductive pin 43f are electrically connected with each other to form a third circuit; and the electrically conductive pin 43g, the electrode contact 421g, the second LED chip 541, the electrode contact 421h and the electrically conductive pin 43h are electrically connected with each other to form a light-modulation circuit.

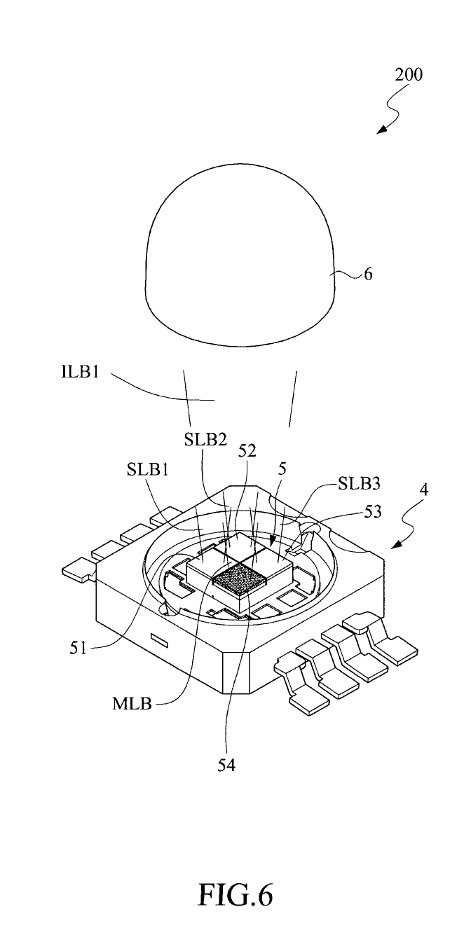

Please refer to FIG. 6, which illustrates that in the preferred embodiment of the present invention, a second light beam projected from the second LED chip is stimulated after transmitting through the light-transmissible layer, and mixed with three first light beams projected from the three first LED chips to generate an illumination light beam. As shown in FIG. 6, after independently supplying the driving currents to the first circuit, the second circuit, the third circuit and the light-modulation circuit, the first LED chips 51, 52 and 53 project three first light beams SLB1, SLB 2 and SLB 3 respectively, and the second LED chip 541 projects a second light beam MLB. The second light beam MLB is stimulated after transmitting through the light-transmissible layer 542 containing phosphor powder, and further mixed with first light beams SLB1, SLB 2 and SLB 3 after being stimulated, so as to generate an illumination light beam ILB 1, which can provide illumination to external environment.

In practical applications, the first light beams SLB1, SLB2 and SLB3 can be red, green and blue light beams respectively. The second LED chip 541 can be a blue-light LED chip, and the light-transmissible layer can contain yellow phosphor powder; therefore, the second light beam MLB can be stimulated as a first white light beam after transmitting through the light-transmissible layer 542, and further mixed with the red, green and blue light beams to generate a second white light beam (i.e., the illumination light beam ILB1 as mentioned). In the present invention, the first white light beam and the second white light beam widely imply the warm white light beam(s), the neutral white light beam(s) or the cool white light beam(s) ranging from 2000K to 10,000K.

Additionally, in practical applications, the intensities of the first light beams SLB1, SLB2, SLB3, and the second light beam MLB can be controlled by controlling the driving currents passing through to the first circuit, the second circuit, the third circuit, and the light-modulation circuit. Moreover, when the light-transmissible layer 542 is made by injecting light-transmissible gel, the existence of the height deviation Δ h also can prevent the light-transmissible gel from overflowing to cover the first LED chips 51, 52 and 53 neighboring to the second LED chip 541.

Finally, for further verifying the effects of the present invention, experiments regarding the luminous efficacy and homogeneousness of color temperature distribution are investigated. From the experiment results, when the first LED chips 51, 52, 53 are red-light, green-light and blue-light LED chips, the second LED chip is a blue-light LED chip, and the light-transmissible layer 542 contains yellow phosphor powder; the illumination light beam ILB1 is said second white light beam with a luminous efficacy approximate to 80 lumens per watt. Additionally, the maximum spatial deviation of color temperature of the second white light beam is less than 1000 K. Obviously, the luminous efficacy and the homogeneousness of the color temperature distribution of the second white light beam are better than those of the white light beam in prior arts.

Any person skilled in ordinary arts can easily realize that, although in the present invention, only the white light beam modulation technology is disclosed to verify the effects of raising luminous efficacy and improving homogeneousness of color temperature distribution; however, in another illumination light beam modulation technologies, the means as disclosed in the present invention also can be applied to obtain similar effects.

Although the present invention has been described with reference to the preferred embodiments thereof, it is apparent to those skilled in the art that a variety of modifications and changes may be made without departing from the scope of the present invention which is intended to be defined by the appended claims.

What is claimed is:

1. A light emitting diode (LED) illumination assembly, comprising:
a base formed with a receiving groove, and comprising:
at least one first arrangement region located within the receiving groove; and
at least one second arrangement region located within the receiving groove, neighboring to the first arrangement region, and recessed from the first arrangement region in a recessed depth; and
at least one first LED chip mounted on the first arrangement region, and projecting at least one first light beam; and
at least one light modulation subassembly, comprising:
a second LED chip mounted on the second arrangement region, and projecting a second light beam; and
a light-transmissible layer containing phosphor powder and covering the second LED chip;
wherein the second light beam is stimulated after transmitting through the light-transmissible layer, and mixes with the first light beam to generate an illumination light beam thereafter.

2. The LED illumination assembly as claimed in claim 1, wherein said at least one first LED chip comprises a red-light LED chip, and said at least one first light beam comprises a red light beam.

3. The LED illumination assembly as claimed in claim 1, wherein said at least one first LED chip comprises a green-light LED chip, and said at least one first light beam comprises a green light beam.

4. The LED illumination assembly as claimed in claim 1, wherein said at least one first LED chip comprises a blue-light LED chip, and said at least one first light beam comprises a blue light beam.

5. The LED illumination assembly as claimed in claim 1, wherein the second LED chip is a blue-light LED chip, the light-transmissible layer containing yellow phosphor powder, and the second light beam is a first white light beam after being stimulated by the light-transmissible layer.

6. The LED illumination assembly as claimed in claim 1, further comprising a light-transmissible packaging cover for covering the receiving groove.

7. The LED illumination assembly as claimed in claim 1, further comprising at least two pairs of electrode legs electrically connected with said at least one first LED chip and the second LED chip, and extended out of the receiving groove.

8. The LED illumination assembly as claimed in claim 1, wherein the illumination light beam is a second white light beam.
